(19) United States
(12) Patent Application Publication
(10) Pub. No.: US 2006/0012972 A1
(43) Pub. Date: Jan. 19, 2006

(54) Non-powered elongate luminous devices and non-powered elongate luminous devices with mating connectors

(76) Inventor: David K. Sturley, Royal Oak, MI (US)

Correspondence Address: Michael D. Wiggins, 950 Harmon ST., Birmingham, MI, 48009, US

(21) Appl. No.: 11/026,936

(22) Filed: Dec. 30, 2004

Related U.S. Application Data
(63) Continuation-in-part of application No. 10/977,592, filed on Oct. 29, 2004.
Application No. 10/977,592 is a continuation-in-part of application No. 09/810,353, filed on Mar. 16, 2001, now Pat. No. 6,828,043.

(51) Int. Cl. F21V 9/16

(52) U.S. Cl. 362/84; 362/396; 250/462.1

(57) ABSTRACT

A non-powered luminous device comprises an elongate member. The elongate member is made of plastic and is at least one of transparent and/or translucent. The elongate member includes luminescent material that is suspended in the plastic before extruding. A non-powered luminous device comprises an elongate member that is at least one of transparent and/or translucent, that defines a cavity and that has first and second ends. A luminous material is located in the cavity and in contact with inner walls of the cavity and includes a light transmissive resinous material containing a suspension of luminescent particles. A first fastener is attached to the first end of the elongate member. A second fastener is attached to the second end of the elongate member. The first and second fasteners are mating fasteners.

### CROSS-REFERENCE TO RELATED APPLICATIONS

This application is a continuation-in-part of U.S. patent application Ser. No. 10/977,592, filed Oct. 29, 2004, which is a continuation-in-part of U.S. Pat. No. 6,828,043, issued Dec. 7, 2004. The disclosures of the above applications are hereby incorporated by reference in their entirety.

### FIELD OF THE INVENTION

The present invention relates to luminous panels and devices, and more particularly to non-powered luminous devices containing luminescent particles.

### BACKGROUND OF THE INVENTION

Luminous panels and devices are often used for signs, decorations and markings. The luminous panels typically require electricity to operate. These luminous-panels usually include a powered light source such electroluminescent elements, light emitting diodes (LEDs), neon light bulbs, incandescent light bulbs and/or fluorescent light bulbs.

When the normal power source is unavailable, the luminous panels are unable to provide illumination unless backup systems are used. In other words, in emergency situations when the normal power source is not available, these luminous panels must be connected to a backup power source such as batteries. Alternately, a backup generator may be used. As can be appreciated, the batteries will require maintenance personnel to perform periodic testing and/or replacement, which can be costly. Backup generators are also costly and may be damaged during emergency situations.

Some building codes require stairwells and halls to be illuminated by non-powered light sources to a prescribed level when power is lost. When an emergency occurs, the non-powered sources provide light that help building occupants safely exit the building. In one approach, paint containing luminescent particles has been used. Light that is absorbed by the luminescent particles is released with the light source is removed. However, paint containing luminous particles has typically been unable to meet the specifications relating to the duration that the light must be provided. This approach may also fail to provide a sufficient amount of light or intensity. Durability may also be problematic.

Non-powered luminous panels and devices have a variety of other applications. Law enforcement personnel often need respond to dangerous situations. For example, when law enforcement personnel respond to a robbery in progress, there may be an armed robber in the vicinity. In the heat of the ensuing action, it may be difficult for one law enforcement person to differentiate between other law enforcement personnel and the armed robbers.

Some law enforcement personnel attach a non-powered luminous device to identify themselves as law enforcement personnel and to prevent accidental misidentification. These non-powered luminous devices typically include a brittle inner tube such as glass, breakable plastic or other material within a semi-flexible outer tube such as plastic. When the device is bent, the inner tube breaks. Chemicals in the inner tube mix with chemicals in the outer tube. The chemical reaction creates a luminous mixture. When these luminous devices are initially activated, they typically provide too much light, which can be a distraction and/or can draw attention to the law enforcement personnel. These luminous devices tend to last for a short period and are typically single use devices.

### SUMMARY OF THE INVENTION

A non-powered luminous device comprises an elongate member. The elongate member is made of plastic and is at least one of transparent and/or translucent. Luminescent material is added to the plastic before extrusion.

In other features, the elongate member defines a cavity. The luminous material contains about 4 to 40 grams of the luminescent particles per 100 cc of the plastic. The luminous material contains about 11 to 20 grams of the luminescent particles per 100 cc of the plastic. The elongate member is flexible. The elongate member has one of circular, elliptical, polygonal, square, or rectangular cross section.

In other features, the luminous particles comprise MO·a(a1_{1-b}B_{b})₂O₃:cR wherein: 0.5≦a≦10.0,0.0001≦b≦0.5 and 0.01≦c≦0.2, MO represents at least one divalent metal oxide selected from the group consisting of MgO, CaO, SrO and ZnO and R represents Eu and at least one additional rare earth element selected from the group consisting of Pt, Nd, Dy and Tm. The luminescent particles are comprised of a sinter expressed by a general formula MO·(n−x){aAl₂O₃^{a}÷)(1−a)Al₂O₃^{y}}B₂O₃:R wherein M represents an alkaline earth metal, R represents a rare earth element, 0.5<a≦0.99, 0.001≦x≦0.35, and 1≦n≦8.

In other features, the luminous material includes luminous particles that absorb light from a light source and reemit the light energy in a first wavelength spectrum when the light source is removed mixed with a material selected from the group consisting of fluorescent colorants and optical brighteners which are excited by absorbing light at a first wavelength spectrum and reemitting the absorbed light at a second wavelength.

A system comprises the non-powered luminous device and further comprises a first fastener attached to one end of the elongate member. A second fastener is attached to an opposite end of the elongate member. The first and second fasteners are mating fasteners.

A non-powered luminous device comprises an elongate member that is at least one of transparent and/or translucent, that defines a cavity and that has first and second ends. A luminous material is located in the cavity and in contact with inner walls of the cavity and includes a light transmissive resinous material containing a suspension of luminescent particles. A first fastener is attached to the first end of the elongate member. A second fastener is attached to the second end of the elongate member. The first and second fasteners are mating fasteners.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first embodiment of the present invention;

FIG. 2 is a perspective view of a second embodiment of the present invention;

FIG. 3 is a perspective view of a third embodiment of the present invention;

FIG. 4 is a perspective view of a fourth embodiment of the present invention;

FIG. 5 is a perspective view of a non-powered luminous device according to some embodiments of the present invention;

FIGS. 6A-6F are cross sectional views of exemplary elongate members;

FIG. 7 illustrates apparatus for making the non-powered luminous device of FIG. 5;

FIG. 8A illustrates an exemplary device for rotating the elongate member during curing;

FIG. 8B illustrates an exemplary device for rotating and heating the elongate member during curing;

FIGS. 9A-9D are flowcharts illustrating steps of a method for making the non-powered luminous device;

FIG. 10 illustrates a system including the non-powered luminous device, first exemplary mating attachments, and an object;

FIG. 11 illustrates a system including the non-powered luminous device, second exemplary mating attachments, and an object;

FIG. 12 illustrates a system including the non-powered luminous device, double-sided tape, and an object;

FIG.. 13 illustrates a system including a first exemplary handrail including a slot for receiving the non-powered luminous device;

FIG. 14 illustrates a system including the non-powered luminous device and a second exemplary handrail;

FIG. 15 illustrates a recharging device for a non-powered luminous device and/or a luminous panel;

FIG. 16 is a side view of an elongate luminous device including male and female connectors that connect opposite ends thereof;

FIG. 17 is a side view of an elongate luminous device including a flexible member that flexibly connects opposite ends thereof;

FIG. 18 is a perspective view of an elongate member that defines a cavity and that includes plastic that is impregnated with luminous material before extrusion;

FIG. 19 is a cross sectional view of the elongate member of FIG. 18;

FIG. 20 is a perspective view of an elongate member that includes plastic that is impregnated with luminous material before extrusion; and

FIG. 21 is a cross sectional view of the elongate member of FIG. 20.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements.

Referring now to FIG. 1, a first embodiment of a non-powered luminous panel according to the present invention is shown. The non-powered luminous panel includes a bottom plate 2 and a top plate 4. In this embodiment, the plates 2 and 4 are illustrated as being rectangular. However, skilled artisans can appreciate that the plates 2 and 4 can be circular, square or any other desired shape.

The plates 2 and 4 are made from a transparent or translucent material such as glass or plastic. At least the top surface of plate 2 and the bottom surface of plate 4 are substantially flat. An interlayer 6 of a luminescent resinous material is provided between the plates 2 and 4. The layer of luminescent resinous material 6 can be coated onto the plate 2 by any known method. Subsequently, the plate 4 is placed on top of the layer 6. The luminous panel may be of any thickness depending on the use. In some embodiments, the thickness of the luminous panel is in the range of 3/16″ to 1-¼″.

The interlayer 6 includes a clear resinous material such as polyester or styrene resins with a dispersion of luminescent particles therein. The resinous material need only be light transmissive, capable of curing by heat, infrared, x-rays, ultraviolet light, passage of time, etc., act as an adhesive and be compatible with the particles of luminescent material.

The resinous material in the interlayer 6 is typically formed by adding about 50 grams of luminescent particles to 1000 cc of resinous material. To this, small amounts of additives may be mixed into the resinous materials. Such additives may include an adhesion promoter and catalyst to cause the resinous material to harden. The thickness of the interlayer 6 depends upon the application and is preferably in the range equal to 0.010 to 0.150 inches. However, the greater the thickness of the interlayer 6, the greater is the chance of a deflection of the interlayer 6 which may result in a breaking of one or both of the plates 2 and 4.

Suitable luminescent particles are those such as the long decay phosphors of U.S. Pat. No. 5,376,303, the long afterglow phosphor of U.S. Pat. No. 5,885,483 and the photostorage and emissive material of U.S. patent application Ser. No. 09/166,199, which was filed on Oct. 5, 1999. The long decay phosphor of U.S. Pat. No. 5,376,303 is comprised of MO·a(A1_{1-b}B_{b})₂O₃:cR herein:
0.5≦a≦10.0,
0.0001≦b≦0.5 and
0.0001.≦c≦0.2,

MO represents at least one divalent metal oxide selected from the group consisting of MgO, CaO, SrO and ZnO and R represents Eu and at least one additional rare earth element selected from the group consisting of Pt, Nd, Dy and Tm. In U.S. Pat. No. 5,885,483, the long afterglow phosphor comprises a sinter expressed by a general formula MO·(n−x){a A1₂O₃a*(1−a)A1₂O₃^{y}}B₂O₃:R wherein M represents an alkaline earth metal, T represents a rare earth element, 0.5<a≦0.99, 0.001≦x≦0.35, 1≦n≦8 and a part of M may be replaced with at least one alkaline earth metal selected from the group consisting of Mg, Ca and Ba.

The photostorage and emissive material of U.S. patent application Ser. No. 09/166,199 is composed of luminescent material which absorbs light from a light source. The luminescent material re-emits the light energy in a first wavelength spectrum when the light source is removed. A second material is mixed with the luminescent material. The second material is selected from the group consisting of fluorescent colorants and optical brighteners that absorb light at the first wavelength spectrum and re-emit the absorbed light at a second wavelength spectrum.

In use, the non-powered luminous panel absorbs light energy into the luminous particles contained in the interlayer 6. The light energy is thereby stored in the interlayer 6 and continues to be stored so long as the source of light is present. Once the source of light is removed by either the sun going down, the other powered sources of light energy being turned off (for example by power failure or other emergency), the interlayer 6 will emit light energy in the visible spectrum and the non-powered luminous panel will be easily visible.

Referring back to FIG. 1, indicia such as letters 8, which form either a direction or emergency notice sign such as the letters EXIT, can be printed in opaque letters on the top surface of the plate 4. When the interlayer 6 emits light energy in the visible spectrum, the indicia 8 can easily seen and the sign easily read.

Referring now to FIG. 2, a second embodiment of the present invention is shown. All of the elements are similar except that the plate 2′ is made thinner in FIG. 2 than the plate 2 in FIG. 1, the plate 4′ is made thicker than the plate 4 in FIG. 1 and the indicia 8′ are formed in inverse. By varying the relative thickness of the plates, it is possible to change the strength of the overall luminous plate to suit the particular application. Also by printing the indicia in reverse such as the indicia 8′ in FIG. 2, the luminous light energy in the visible spectrum will be visible from the luminous panel as letters. In some situations, the letters in FIG. 2 may be more visible than the construction shown in FIG. 1.

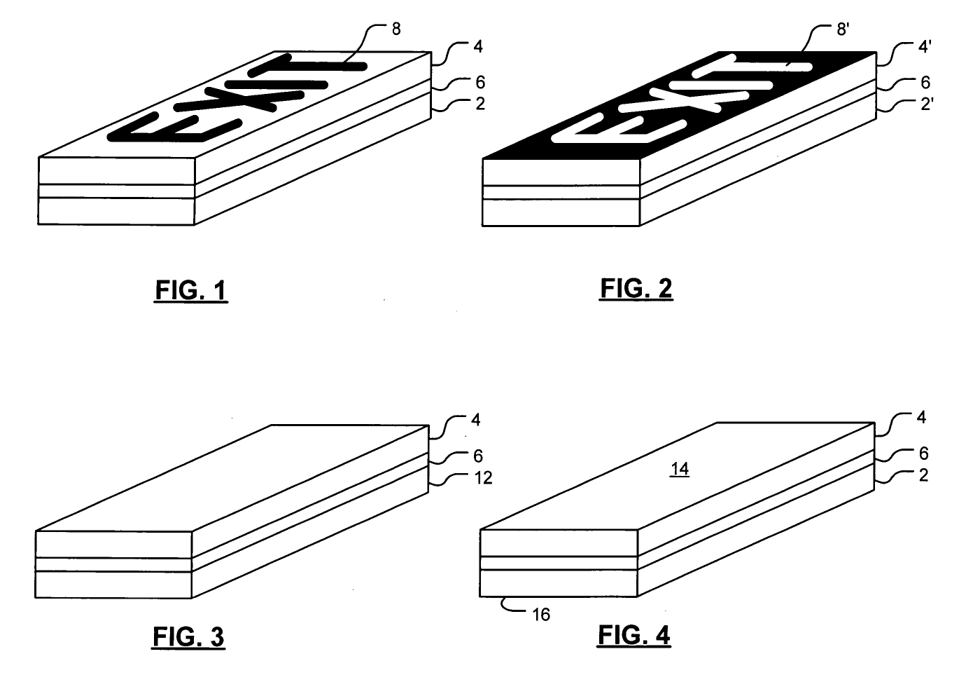

Referring now to FIG. 3, a third embodiment of the present invention is shown. The bottom plate 2 is eliminated. In its place, a protective layer 12 is provided. The protective layer 12 may comprise aluminum or tin foil or a suitable plastic film that protects the bottom surface of the interlayer 6. Otherwise, the embodiment of FIG. 3 functions in the same way the embodiments of FIGS. 1 and 2. However, this embodiment only emits light from one side.

Referring now to FIG. 4, a fourth embodiment of the present invention is shown. In this embodiment, the top surface 14 of the top plate 4 and/or bottom surface 16 of the bottom plate 2 may be half silvered to allow light to enter the non-powered luminescent plate but be reflected or trapped between the top and bottom plates 2 and 4 by the partial or half silvered layers 14 and 16. In this way, the light capturing ability of the non-powered luminous plate may be enhanced.

Still further, in other applications, the top or bottom surface of the plate 2 that is in contact with the interlayer 6 can be provided with a completely mirrored surface. By providing the completely mirrored surface, the light that is emitted by the interlayer 6 is reflected by the mirror and exits the top surface 14 of the upper plate 4. Still further and in other embodiments, the interlayer 6 further comprises reflective particles to further enhance the emission of light and to provide a more aesthetic appearance.

Using the photostorage and emissive material of U.S. Ser. No. 09/166,199, it is possible to provide an interlayer 6 having different colors. In other words, the interlayer 6 can be any color such as red, green, blue, purple, etc. By utilizing the photostorage and emissive material of U.S. application Ser. No. 09/166,199, the color of the luminous panel and the color of the light emitted from the non-powered luminous panel can be selected based upon esthetics or the use. For example, for emergency signs or uses, it may be desirable to provide the interlayer 6 in red. Finally, in some applications, it may be useful to utilize a colored light transmissive material for the plates 2 and 4, depending on the use and the aesthetics.

It should be apparent to those skilled in the art that the uses of the non-powered electroluminescent panel of the present invention is particularly broad. In particular, because of the varying ways in which the luminous panel of the present invention can be manufactured, such non-powered luminous panels can be used for safety, novelty and/or decoration. For commercial uses, it can be used as an interior or exterior glazing and provide navigational light and security in entrances and atriums. In public parking structures, it can be mounted to walls and handrails for navigational and direction and include letters and arrows to further enhance the security and safety of the parking structure. Still further, it can be installed on the vertical risers of steps and stairways to easily mark the steps and thereby increase the safety in both commercial and residential settings.

Other uses of the luminous panel include but are not limited to pavers made entirely of light transmissive material or composites of brick, mortar, and/or cement with a portion made of light transmissive material embedded therein to mark sidewalks and driveways, table tops, shower door glass, doors and door moldings, lens covers for incandescent and fluorescent lights, light shades and commercial signage.

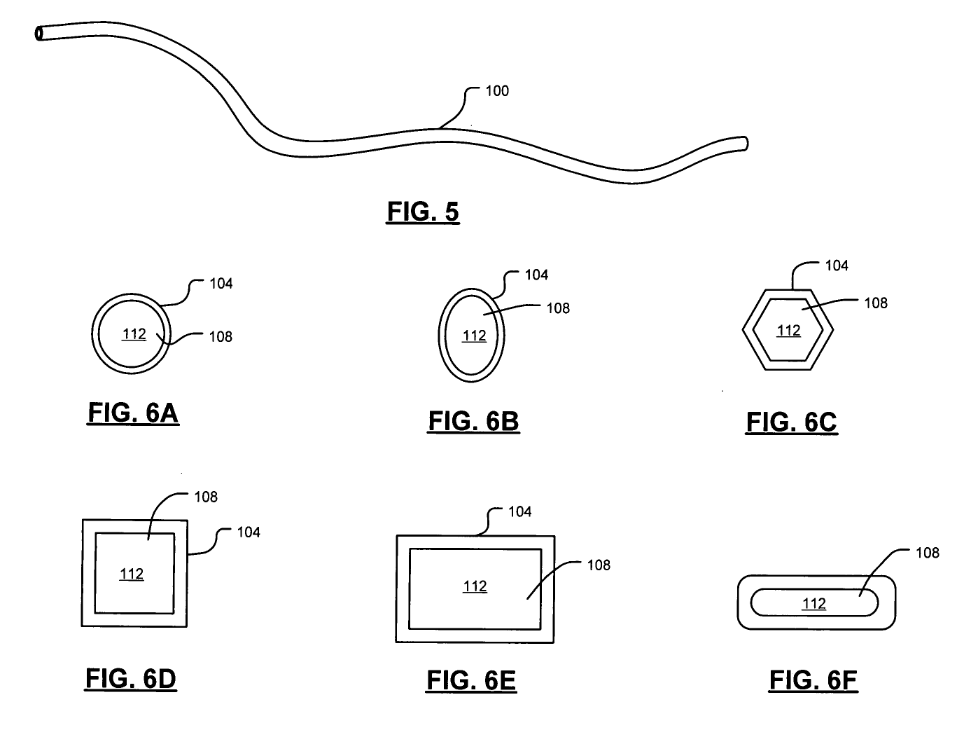

Referring now to FIGS. 5 and 6A-6F, a non-powered luminous device 100 according to the present invention includes an elongate member 104 that defines an inner cavity 108. The term elongate is used herein to mean a length that is at least two times greater than a cross-sectional width. The elongate member 104 can be made of any transparent and/or translucent material. In some embodiments, the elongate member 104 is flexible. In some embodiments, the elongate member 104 is made of plastic such as but not limited to vinyl. The elongate member 104 can have a variety of cross-sections including, but not limited to, circular (FIG. 6A), elliptical (FIG. 6B), polygonal including N sides where N is greater than three (FIG. 6C), square (FIG. 6D), rectangular (FIG. 6E), rounded rectangular (FIG. 6F), or any other suitable shape. The inner cavity 108 of the elongate member 104 receives luminescent resinous material 112 that contains luminous particles, as previously described the embodiments above and as will be described in the embodiments below.

In some embodiments, the luminescent resinous material remains pliable after curing. Having a pliable non-powered luminous device facilitates bending and improves durability by reducing cracking. In some embodiments, a tackiness enhancing material is added to the resin-based solution to improve the adhesion of the resin-based solution to inner walls of the cavity 108. In some embodiments, a catalyst or hardener can be added to the luminescent resinous material to reduce the curing time. For example, the resin material can be ASTROCURE 5000G available from Zircon Corporation of Collierville, Tenn. and/or low shrinkage resin from Glasslam H. G. I, Inc. of Pompano Beach, Fla. For example, the tackiness enhancing material can be organic silane available from ASTROCURE P-88-2 (Gamma Methacryloxypropyltrimethoxysilane) available from Zircon Corporation. For example, the catalyst or hardener can be organic peroxide such as Organic Peroxide Type D or ASTROCURE C-88 available from Zircon Corporation.

The luminous particles can be the luminescent particles described above and in the concentrations described above (hereinafter high light (HL) luminescent particles). The luminescent particles are called HL due to their ability to be charged by outdoor light—sunlight—with only ordinary degradation of the luminescent particles. In other embodiments, a low light (LL) luminescent particles is used alone or in combination with the HL luminescent particles. The LL luminescent particles have a shorter charge time. The LL luminescent particles charge with indoor sources of light but experience accelerated degradation if changed with outdoor light. The LL luminescent particles are preferably GLL300M available under the trademark Luminova® from United Mineral and Chemical Corp. of Lyndhurst, N.J. and Nemota & Co. LTD. of Tokyo, Japan. The HL luminescent particles are preferably G300, BG300 or V300 available under the trademark Luminova® from United Mineral and Chemical Corp. and Nemota & Co. LTD. of Tokyo, Japan. As can be appreciated, the luminous panels described above can also be implemented using LL, HL and/or LL and HL luminescent particles.

In some embodiments of the non-powered luminous device and luminous panels, approximately 4-40 g of luminescent particles are added to each 100 cc of resin. In other embodiments, approximately 11-20 g of luminescent particles are added to each 100 cc of resin. If the tackiness enhancer is used, preferably 0.5 to 2 cc is added for each 100 cc of resin in some embodiments. If the catalyst or hardener is used, approximately 0.5 to 2 cc is added for each 100 cc of resin in some embodiments.

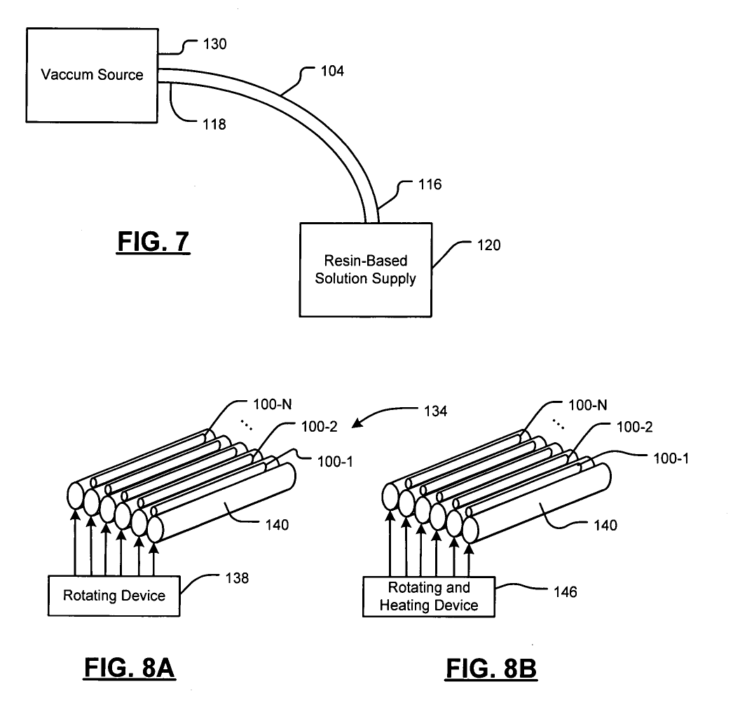

Referring now to FIG. 7, one end 116 of the elongate member 104 is in fluid communication with a supply 120 that includes the luminescent resinous material. An opposite end 118 of the elongate member 104 is in fluid communication with a vacuum source 130. In use, the vacuum source 130 draws the luminescent resinous material into the cavity 108 of the elongate member 104. While a vacuum source 130 is shown, gravity and/or pressure based systems can also be used.

Referring now to FIGS. 8A and 8B, exemplary curing devices are shown. In FIG. 8A, the curing device 134 includes a rotating device 138 that rotates rollers 140. The non-powered luminous device 100-1, 100-2, . . . , 100-N are positioned on the rollers 140. Preferably, the rollers 140 rotate the non-powered luminous device 100 at a rate that is greater than or equal to 1 revolution every 50 seconds. By rotating the non-powered luminous devices 100 during curing, the luminescent particles will remain in solution until curing is complete. This will ensure that the non-powered luminous devices 100 have uniform light intensity from all directions during emission.

In FIG. 8B, a rotating and curing device 146 rotates the rollers 140 and uses a curing enhancement. For example, the rollers can be heated. For example, the rollers can be heated and/or an infrared heat source can be used. The heated rollers 140 heat the non-powered luminous devices 100 to facilitate curing. In some embodiments, the heating portion is separate from the rollers 140. In other embodiments, the heating portion is integrated with the rollers 140. Any source of heat may be used including heat radiating surfaces, hot air, and/or other known heat sources. Ultraviolet might may also be used. Temperatures above ambient and less than a melting point of the elongate member are preferably used. Other variations will be apparent to skilled artisans.

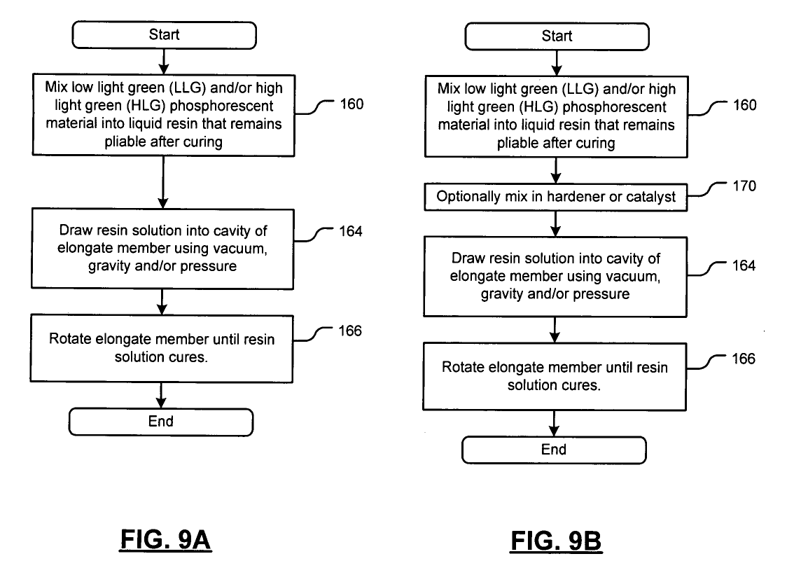

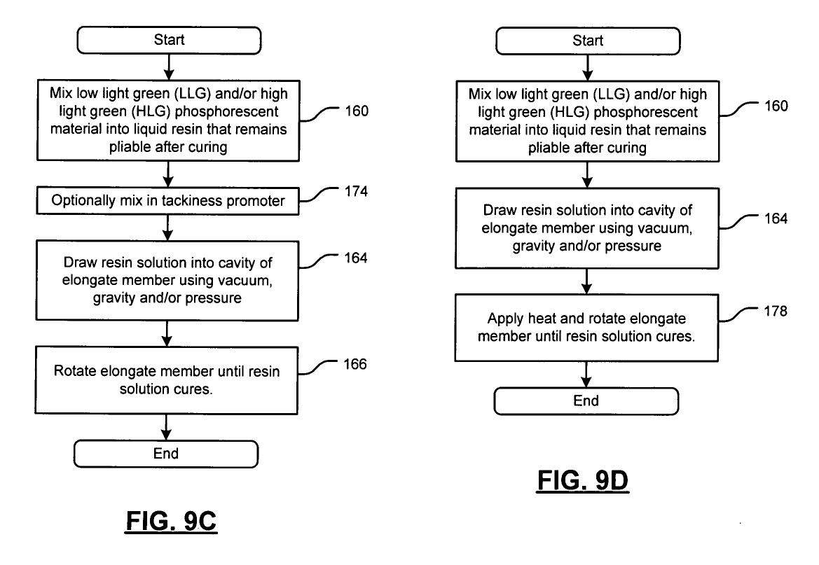

Referring now to FIGS. 9A-9D, various exemplary methods for making the non-powered luminous device 100 are shown. In FIG. 9A, the LL and/or HL luminescent particles are mixed with the resinous material in step 160. In step 164, the luminescent resinous material is drawn into the cavity 108 of the elongate member 104 using vacuum, pressure and/or gravity. In step 166, the elongate member 104 is rotated until the resin cures. In FIG. 9B, an optional hardener or catalyst is added to the luminescent resinous material before curing in step 170. In FIG. 9C, an optional tackiness promoter is mixed into the luminescent resinous material before curing in step 174. In FIG. 9D, both heat and rotation are optionally performed during curing in step 178. Alternately ultraviolet light may be used. As can be appreciated, the steps of the methods shown in FIGS. 9A-9D can be combined and/or arranged in other permutations without departing from the scope of the present invention.

Referring now to FIGS. 10 and 11, mating attachment devices 200 and 204 are used to attach the flexible phosphorescent light supply 100 to an object 210. For example, the mating attachment devices 200 and 204 can be male and female connectors such as Velcro or other types of male and female mating attachments. If Velcro is used, adhesive is preferably used to attach one of the Velcro portions to one side of the non-powered luminous device 100. Adhesive is also used to attach the mating Velcro portions to the object 210.

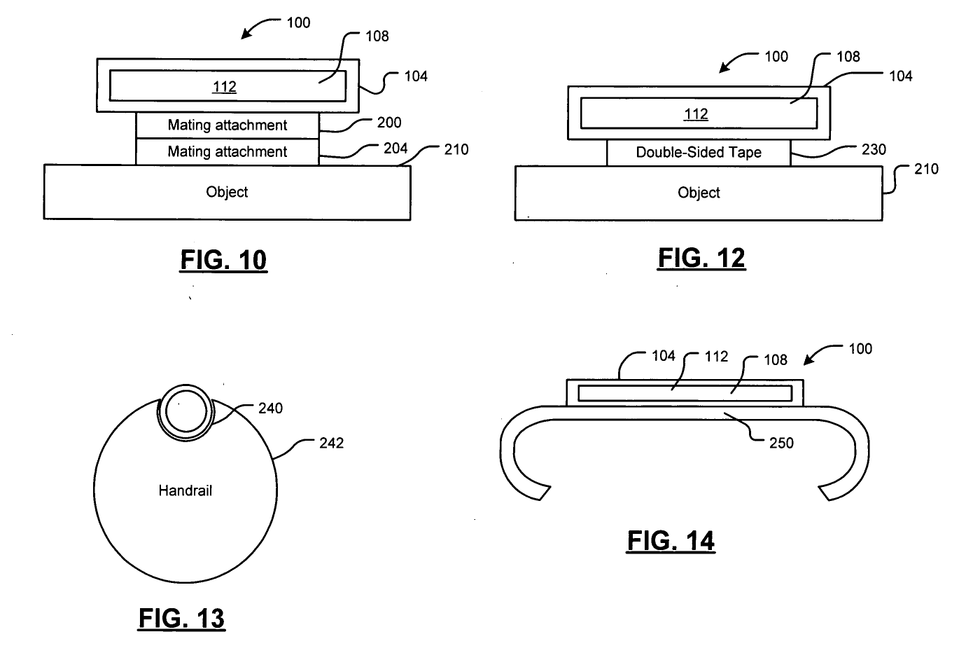

In FIG. 11, male and female interlocking elements 220 and 224 are used to attach the flexible phosphorescent light supply 100 to the object. Still other types of mating attachments can be used. Referring now to FIG. 12, double-sided tape 230 is used to attach the non-powered luminous device 100 to the object 210. Any other type of fastening device may be used.

In FIG. 13, a slot 240 is formed in a handrail 242. The slot 240 removably receives the non-powered luminous device 100. As can be appreciated, the non-powered luminous device can be removed from the slot 240 and replaced if needed. The non-powered luminous device can be used when powered light sources are unavailable.

In FIG. 14, a handrail 250 having a C-shaped cross-section is shown. A rectangular non-powered luminous device 100 is shown attached to an upper surface thereof. Still other cross-sectional shapes may be used for the handrail and/or the luminous device 100. The same types of attachment devices may also be used to attach luminous panels to objects.

Law enforcement personnel sometimes need a non-powered light source for quick identification during emergency and/or dangerous situations. For example, when responding to a crime scene with armed suspects, the law enforcement personnel must quickly decide whether an armed person is friend or foe. Attaching a luminous device such as those described above may help law enforcement personnel quickly decide whether the armed person is a friend or foe.

The non-powered light source can be small luminous panel or luminous device. For example, the luminous panel or device can be made of plastic and include attachment devices such as those described above. The luminous device may be self attaching such as a ring shape that can be worn around the neck, arm, legs, waist, etc. The luminous panel may include one or more light transmissive layers that are made of plexiglass or other bullet resistant material. The luminous panel and/or device may include HL and/or LL luminous particles. Advantages of LL include reduced charge time as compared to HL. The luminous panel may be attached to the uniform of the law enforcement personnel using Velcro or other attachment types. For example, the luminous panels may be attached on the front and/or back of the law enforcement personnel.

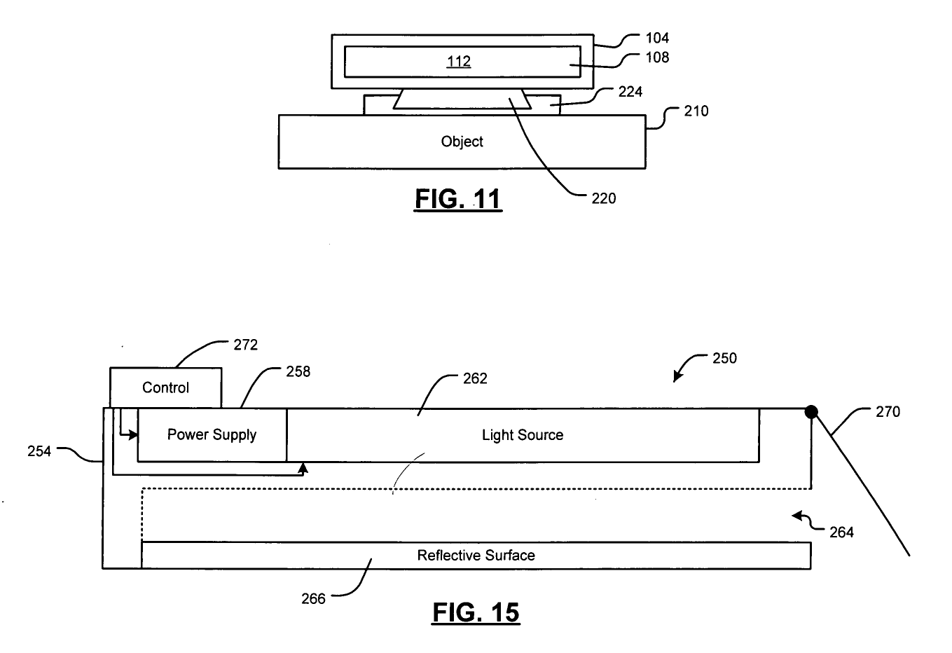

Since the law enforcement personnel may be in the field, a convenient source of light is needed. Referring now to FIG. 15, a charging device 250 is shown to include a housing 254 that includes a power supply 258, a light source 262, and one or more slots 264 for receiving one or more of the luminous panels and/or luminous devices 100. The charging device 250 can be used to charge the LL-based, HL-based and/or LL and HL-based luminous devices.

While a generally rectangular shape is shown, the housing 254 may have any suitable shape. The power supply 258 may be an AC source and/or a DC source such as batteries or a vehicle adaptor. The light source 262 can be any suitable source that excites the luminescent particles including but not limited to black light, incandescent light, light emitting diodes, etc. One or more inner surfaces of the housing 254 can be coated with a reflective material or mirrored to increase the charging efficiency of the light source. A door 270 can be used to enclose an end of the charging device 250 that receives the luminous panel or a luminescent resinous material. A control 272 may include an on/off switch 272 that is used to turn the light source on or off. In some embodiments, the control 272 may include a timer that sets the amount of time that the light source is on and/or a delay until the light turns on. The control 272 may be programmable to start and stop.

In use, the luminous panel and/or luminous device is inserted into the slot 264. The control 272 is used to turn on the light source 262. After the luminous panel or a non-powered luminous device has been in the slot 264 for a sufficient amount of time with the light source on, it becomes charged. The luminous panel or luminous device is removed attached to the object or person.

The elongate member 104 can be made in longer sections and cut into shorted sections during manufacture and/or after sale. The shorter sections can be used as “breadcrumbs” to mark a path to provide a marking for the return trip at night or other low light situations.

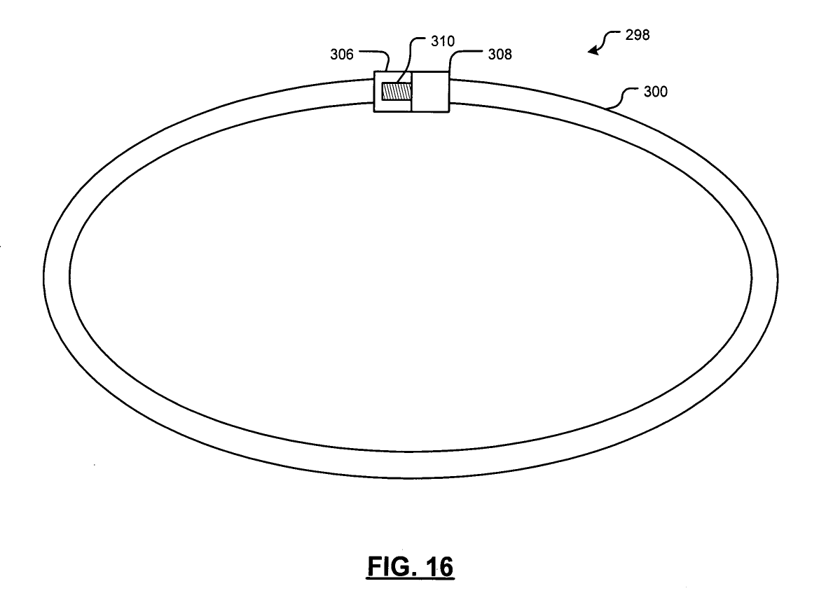

Referring now to FIG. 16, an elongate luminous device 298 is shown to including an elongate member 300 having a female connector 306 connected to one end. A male connector 308 is connected to an opposite end of the elongate member 300. The female and male connectors 306 and 308, respectively, can be any type of mating connector.

For example, the male connector 308 can include a threaded stud 310 and the female connector 306 can include a threaded bore that receives the threaded stud 310. However, skilled artisans will appreciate that the female and male connectors 306 and 308, respectively, can include snap-fit detachable connectors, screw-type connectors, Velcro-type connectors, snaps, zippers, and/or any other type of releasable mating connectors.

The elongate member 300 is a luminous device that is made as described above and/or below. In other words, the elongate member 300 may include a cavity that receives a transparent and/or translucent resinous material containing luminous material and/or the elongate member 300 may include plastic that is impregnated with luminous material as will be described below.

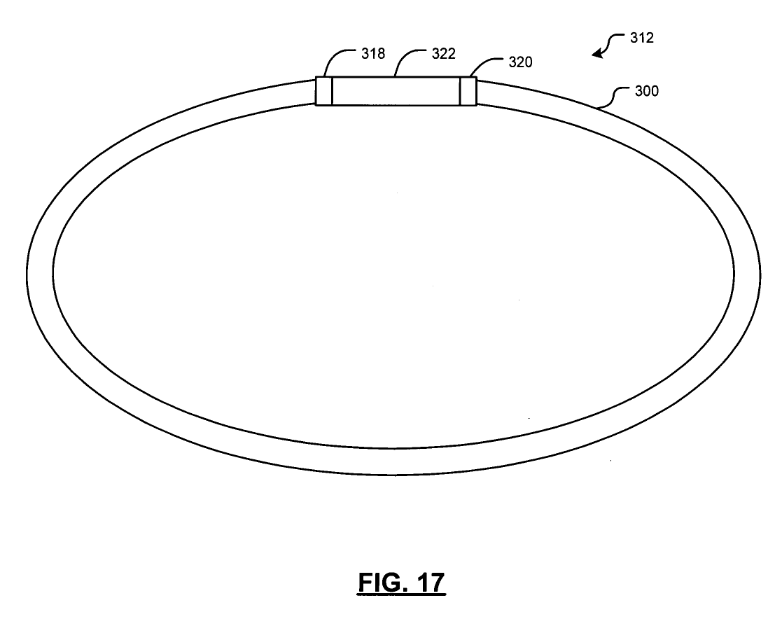

Referring now to FIG. 17, an elongate luminous device 312 includes an elongate member 300, first and second connectors 318 and 320 and a flexible member 322 that extends between the first and second connectors 318 and 320. In some embodiments, the first and second connectors are fixedly attached to the opposite ends of the elongate member 300 using any suitable attachment method such as glue, friction, pressure, mechanical interference, mechanical connectors such as pins, etc.

The elongate luminous devices 298 and 312 can be used in a wide variety of applications. For example, the elongate luminous devices 298 and 312 can be attached to a dog, cat or other animal and used to increase the visibility of the pet. In use, the female and male connectors 306 and 308, respectively, are unfastened and the elongate luminous device 298 is wrapped around the neck or other part of the animal. The female and male connectors 306 and 308, respectively, are fastened together to attach the elongate luminous devices 298 and 312 to the animal. After the elongate luminous devices 298 and 312 are charged by light (while located either on or off of the animal), the elongate luminous devices 298 and 312 will produce light, which increases the visibility of the animal. Still other uses will be apparent including but not limited to use to identify humans, objects, etc. In some implementations, the flexible member 322 is a flexible material such as rubber, flexible fabric, and/or any other suitable flexible material.

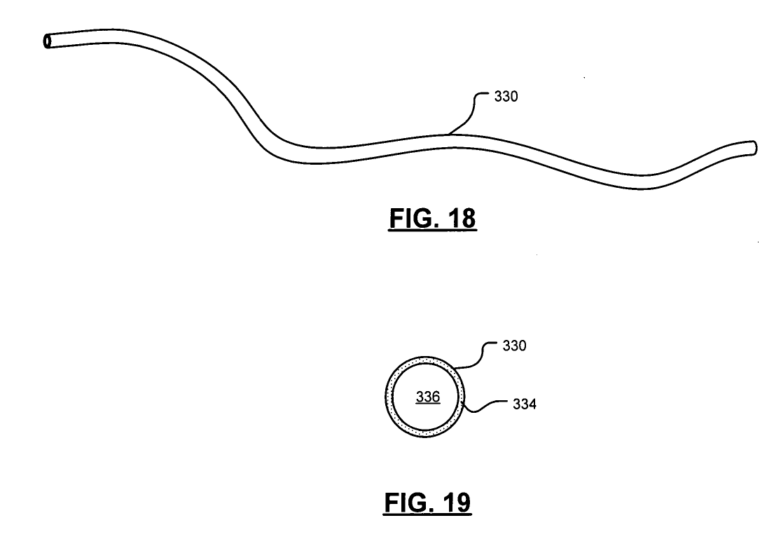

Referring now to FIGS. 18-19, an elongate member 330 defines a cavity 336 and is made of plastic. The plastic is impregnated with the luminous material as shown by arrow 334. In other words, prior to extruding the elongate member 330, the plastic that is used to form the elongate member 330 is impregnated with the luminous material.

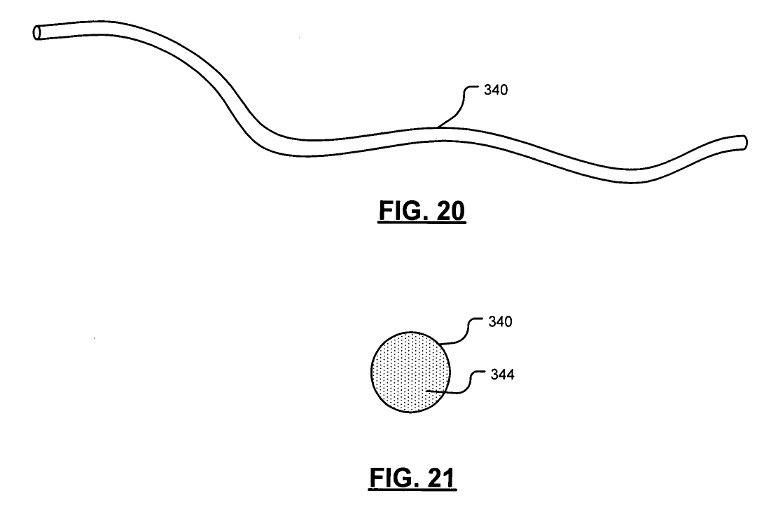

Referring now to FIGS. 20-21, an elongate member 340 is also made of plastic but does not include a cavity as in FIGS. 18-19. The plastic is impregnated with luminous material as shown by arrow 334. In other words, prior to extruding the elongate member 330, the plastic that is used to form the elongate member 330 is impregnated with the luminous material. The amount of luminous material this is used relative to the plastic is similar to the embodiments described above.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A non-powered luminous device, comprising:
an elongate member,
wherein the elongate member is made of plastic,
wherein the elongate member is at least one of transparent and/or translucent,
wherein the elongate member includes luminescent material that is suspended in the plastic.

2. The non-powered luminous device of claim 1 wherein the elongate member defines a cavity.

3. The non-powered luminous device of claim 1 wherein the luminous material contains about 4 to 40 grams of the luminescent particles per 100 cc of the plastic.

4. The non-powered luminous device of claim 1 wherein the luminous material contains about 11 to 20 grams of the luminescent particles per 100 cc of the plastic.

5. The non-powered luminous device of claim 1 wherein the elongate member has one of circular, elliptical, polygonal, square, or rectangular cross section.

6. The non-powered luminous device of claim 1 wherein the luminous particles comprise MO·a(Al_{1-b}B_{b})₂O₃:cR wherein: 0.5≦a≦10.0, 0.0001≦b≦0.5 and 0.01≦c≦0.2, MO represents at least one divalent metal oxide selected from the group consisting of MgO, CaO, SrO and ZnO and R represents Eu and at least one additional rare earth element selected from the group consisting of Pt, Nd, Dy and Tm.

7. A system comprising the non-powered luminous device of claim 1 and further comprising:
a first fastener attached to one end of the elongate member; and
a second fastener attached to an opposite end of the elongate member, wherein the first and second fasteners are mating fasteners.

8. The system of claim 7 wherein the first and second fasteners comprise Velcro.

9. The system of claim 7 wherein the first and second fasteners are male and female connectors.

10. A system comprising the non-powered luminous device of claim 1 and further comprising a handrail including a slot for removably receiving the elongate member.

11. A system comprising the non-powered luminous device of claim 1 and further comprising:
a handrail having a surface; and
an attachment device for attaching the elongate member to the surface.

12. The non-powered luminous device of claim 1 wherein the luminescent particles include at least one of low light green (LLG) luminescent particles and/or high light (HL) luminescent particles.

13. A non-powered luminous device, comprising:
an elongate member that is at least one of transparent and/or translucent, that defines a cavity and that has first and second ends;
a luminous material that is located in the cavity and in contact with inner walls of the cavity and that includes a light transmissive resinous material containing a suspension of luminescent particles; and
a first fastener attached to the first end of the elongate member; and
a second fastener attached to the second end of the elongate member, wherein the first and second fasteners are mating fasteners.

14. The system of claim 13 wherein the first and second fasteners comprise Velcro.

15. The system of claim 13 wherein the first and second fasteners are male and female connectors.

16. The non-powered luminous device of claim 13 wherein the luminous material contains about 4 to 40 grams of the luminescent particles per 100 cc of the light transmissive resinous material.

17. The non-powered luminous device of claim 13 wherein the luminous material contains about 11 to 20 grams of the luminescent particles per 100 cc of the light transmissive resinous material.

18. The non-powered luminous device of claim 13 wherein the luminous material contains at least one of a tackiness promoter and/or a catalyst.

19. The non-powered luminous device of claim 13 wherein the elongate member is flexible and wherein the light transmissive resinous material remains flexible after curing.

20. The non-powered luminous device of claim 13 wherein the resinous material comprises a clear polyester or styrene resin.

21. The non-powered luminous device of claim 13 wherein the elongate member has one of circular, elliptical, polygonal, square, or rectangular cross section.
